(19) United States
(12) Patent Application Publication
(10) Pub. No.: US 2002/0095443 A1
(43) Pub. Date: Jul. 18, 2002

(54) Method for automated generation of interactive enhanced electronic newspaper

(75) Inventor: Mark E. Kovack, Wadeworth, OH (US)

Correspondence Address: FAY, SHARPE, FAGAN, MINNICH & McKEE, LLP, Seventh Floor, 1100 Superior Avenue, Cleveland, OH, 44114-2518, US

(73) Assignee: The Beacon Journal Publishing Company

(21) Appl. No.: 10/050,368

(22) Filed: Jan. 16, 2002

Related U.S. Application Data
(60) Provisional application No. 60/262,189, filed on Jan. 17, 2001.

(51) Int. Cl. G06F 17/00

(52) U.S. Cl. 707/513; 707/100

(57) ABSTRACT

For each newspaper page represented in the PostScript data, the PostScript data are parsed to extract therefrom text data, text position data, font information data, image position data and, preferably, a bitmap of the page. Furthermore, each occurrence of a “page refer,” a URL or an electronic mail address on the page as described by the PostScript data is identified and the location of same on the page is extracted. Also, the PostScript data are processed to identify the story locations and image/advertisement locations on the page. Finally, the PostScript data are processed to identify bookmark data thereon. All extracted information concerning the page is stored in a current page information database. The current page information database for each page of the newspaper is thereafter used together with a predefined page type information database that includes default data that varies depending upon the particular type of newspaper page to be represented. From these two databases, a PDFMark preprocess PostScript file is derived for use by an Acrobat Distiller program to develop a PDF template or layout for the page. Thereafter, the Acrobat Distiller program processes the PostScript input file for the page based upon the PDFMark PostScript file to derive a PDF file of the newspaper page that represents the page in PDF format and wherein all URL's, refers, keywords, and other features of the PDF file are active and can be selected by an end-user using a mouse or like means.

### CROSS-REFERENCE TO RELATED APPLICATION

This application claims priority from and hereby expressly incorporates by reference U.S. provisional application No. 60/262,189 filed Jan. 17, 2001.

### BACKGROUND OF THE INVENTION

The present invention relates generally to the electronic publishing arts. More particularly, the present invention relates to a method for automated generation of an interactive enhanced electronic newspaper that is provided to subscribers and others via CD-ROM, the internet or other public and/or private data network, or any other suitable electronic means. The subject method is particularly adapted for generation of an enhanced electronic newspaper in Adobe PDF format from Adobe PostScript data and will be described with reference thereto. However, those of ordinary skill in the art will recognize that the invention has wider application and can be implemented using programming languages and data formats other than those described herein without departing from the overall scope and intent of the invention.

Generation of “portable document format” (PDF) files from PostScript programs and other types of data is well known. The PostScript language is an interpretive language with graphics capabilities. It is widely used in publishing and other fields to describe the appearance of text, images, graphics and other information on a printed or displayed page. A PDF document is a static data structure that is closely related to the PostScript language. PDF files are designed for efficient random access and include navigational information that facilitates interactive viewing.

Because of the numerous and well known advantages of PDF documents including their high-quality appearance, portability among different computing platforms, and interactive features that facilitate navigation through the document by users, it is highly desirable to create PDF files that represent a newspaper. Furthermore, newspapers are typically generated using the PostScript language and, therefore, generation of a basic PDF file therefrom is straightforward.

Prior PDF newspaper files and the methods for generating same are sub-optimal for a variety of reasons. Owing to the complex structure and layout of a typical newspaper, PDF files generated automatically from PostScript files have heretofore lacked enhancements that facilitate user navigation through the newspaper PDF file. Of course, as those of ordinary skill in the art are aware, these prior PDF files have been manually enhanced with conventional PDF features to improve readability and navigation. However, the manual enhancement process is extremely labor-intensive, time-consuming and, thus, expensive. Also, except for archival purposes, an electronic newspaper must be delivered in a timely manner, e.g., concurrently with the traditional hard-copy newspaper, as it has a limited useful life of about one day.

In light of the foregoing specifically noted deficiencies and others associated with conventional efforts at creating an electronic newspaper, it is been deemed desirable to develop a novel and unobvious method for generating an interactive enhanced electronic newspaper that is implemented without user intervention and in parallel with a conventional newspaper printing process to provide a timely and highly user-friendly electronic newspaper document that can be delivered together with or as a substitute to the conventional printed newspaper.

### SUMMARY OF THE INVENTION

In accordance with a first aspect of the present invention, a method for generating an interactive enhanced electronic newspaper includes receiving a PostScript file that describes the newspaper in terms of a plurality of sections each of which is defined by a plurality of pages. For each newspaper page represented in the PostScript data, the PostScript data are parsed to extract therefrom text data, text position data, font information data, image position data and, preferably, a bitmap of the page. Furthermore, each occurrence of a “page refer,” a URL or an electronic mail address on the page as described by the PostScript data is identified and the location of same on the page is extracted. Also, the PostScript data are processed to identify the story locations and image/advertisement locations on the page. Finally, the PostScript data are processed to identify bookmark data thereon. All extracted information concerning the page is stored in a current page information database. The current page information database for each page of the newspaper is thereafter used together with a predefined page type information database that includes default data that varies depending upon the particular type of newspaper page to be represented including, e.g., editorial page, obituary page, classified advertisement page, etc. From these two databases, a PDFMark preprocess PostScript file is derived for use by an Acrobat Distiller program to develop a PDF template or layout for the page. Thereafter, the Acrobat Distiller program processes the PostScript input file for the page based upon the PDFMark PostScript file to derive a PDF file of the newspaper page that represents the page in PDF format and wherein all URL's, refers, keywords, and other features of the PDF file are active and can be selected by an end-user using a mouse or like means. The current page information database and predefined page type information database are also used to derive PDF header information including, e.g., a title, author, keywords, data, page type, section, etc. The header is combined with the PDF file of the page to derive a PDF output page file. Finally, multiple PDF output page files are combined as desired, e.g., according to section and/or date, so that a combined PDF output file is created. This combined PDF output file is presented to the end-user by any desired medium such as on-line, CD-ROM or any other suitable medium.

In accordance with a more limited aspect of the invention, supplemental image, video, music and/or other files are associated with links embedded in the combined PDF output file so that an end-user is able to access these supplemental files simply by selecting the appropriate link.

One advantage of the present invention resides in the provision of a method for automated generation of an interactive enhanced electronic newspaper that can be carried out in parallel with or in advance of production of a conventional hard-copy newspaper.

Another advantage of the present invention is found in the provision of a method for automated generation of an interactive enhanced electronic newspaper wherein supplemental photographs, videos, text and/or other supplemental information is automatically linked to the interactive enhanced electronic newspaper for access by an end-user as desired.

A further advantage of the present invention is found in the provision of a method for automated generation of an interactive enhanced electronic newspaper wherein all URL's and electronic mail addresses are identified automatically and activated so that an end-user may select same to access a URL or send an electronic mail message.

Still other benefits and advantages of the present invention will become apparent to those of ordinary skill in the art to which the invention pertains upon reading and understanding the following specification.

### BRIEF DESCRIPTION OF THE DRAWINGS

The invention comprises various steps and arrangements of steps, preferred embodiments of which are illustrated in the accompanying drawings that form a part hereof and wherein:

FIG. 1 is a diagrammatic illustration of a first step of a method for automated generation of an interactive enhanced electronic newspaper in accordance with the present invention;

FIG. 2 diagrammatically illustrates generation of a PDFMark preprocess file in accordance with the present invention;

FIG. 3 illustrates use of the PDFMark preprocess file and an associated PostScript input file to generate a PDF file representing a newspaper page in accordance with the present invention;

FIG. 4 is a diagrammatic illustration showing generation of PDF header information from predefined and current page information databases and combination of the PDF header with a previously generated PDF file; and,

FIG. 5 illustrates the combination of multiple PDF output page files into a single combined PDF output file suitable for use by an end-user.

### DETAILED DESCRIPTION OF THE PREFERRED EMBODIMENTS

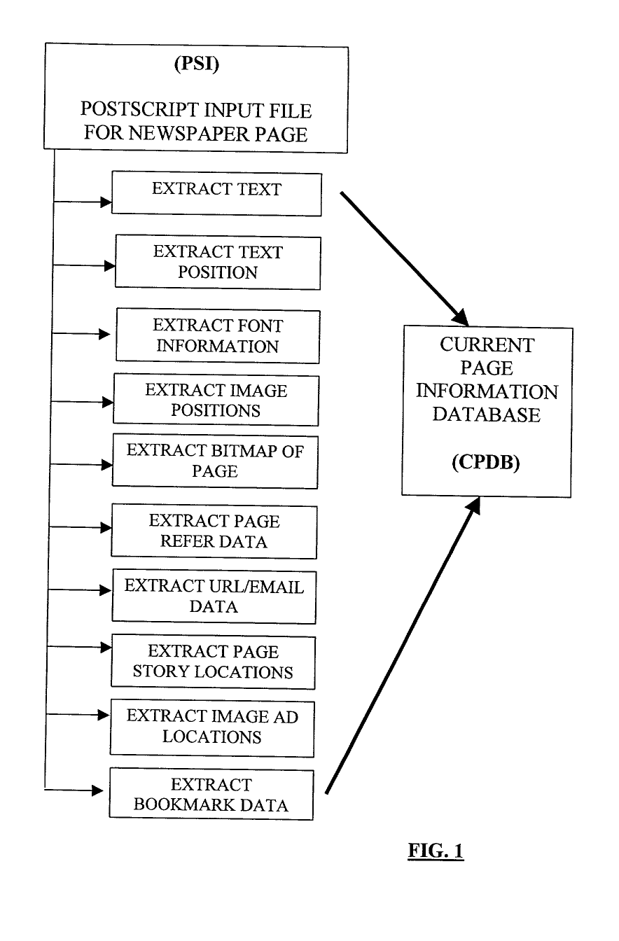

The method for automated generation of an interactive enhanced electronic newspaper in accordance with the present invention is preferably carried out using any suitable computer such as a personal computer or a dedicated computer system. With reference to FIG. 1, newspaper pages are commonly represented in PostScript format, and the present invention comprises receiving a PostScript input file (PSI) for each page of a newspaper to be included in the interactive enhanced electronic newspaper. The PostScript input file (PSI) is processed to extract information therefrom that describes the newspaper page. The PostScript input file (PSI) is preferably parsed to extract therefrom text data, text position data, font information data, image position data, a bitmap of the page, page refer data (a “refer” is a reference to another page of the newspaper for a continuing portion (or beginning) of an article, e.g., “see page 2, col. 3” or “D6”), URL and electronic mail data, page story location data, image ad location data and bookmark data. The extracted data are stored in a current page information database (CPDB).

Those of ordinary skill in the art will recognize that the text is extracted so that it can be processed to look for select page definition data such as refer text, headlines, URL/e-mail text, keywords, fonts, etc. as required to identify particular features of the PostScript input file (PSI). The extracted text position data includes the position of each word of text and the position of each constituent character of each word.

The font information is extracted to allow for identification of particular fonts that are used for headlines, refers, and other unique fonts. The image position/size data allow provide information about the position and size of each image on the page. The bitmap is useful for identifying positions within the PostScript input file (PSI) where other information is to be found, i.e., the bitmap can be used to search through the PostScript input file based upon a particular location of the newspaper page represented in the PostScript input file (PSI).

As noted, the extracted refer data is extracted by looking for particular refer language and/or fonts used to represent the refer on the newspaper page represented in the PostScript input file (PSI). The URL/e-mail data are preferable identified based upon use of text that represents a URL or an electronic mail address, e.g., www.uspto.gov or person@uspto.gov.

The page story location data is derived based upon identification of particular fonts used as headline fonts to begin a story, the font used for story text and also a font change at a story end, i.e., a font change from the story text to a next headline. Thus, the text of the PostScript input file (PSI) is processed from headline-to-headline, with each headline and following text being identified as a separate story on the newspaper page.

The image and advertisement locations and sizes are extracted from the PostScript input file (PSI). Also, bookmark data are extracted from the PostScript input file (PSI). The bookmark data can be headlines, newspaper sectional information and any other information on the newspaper page that will be useful to an end-user for navigation through the PDF file.

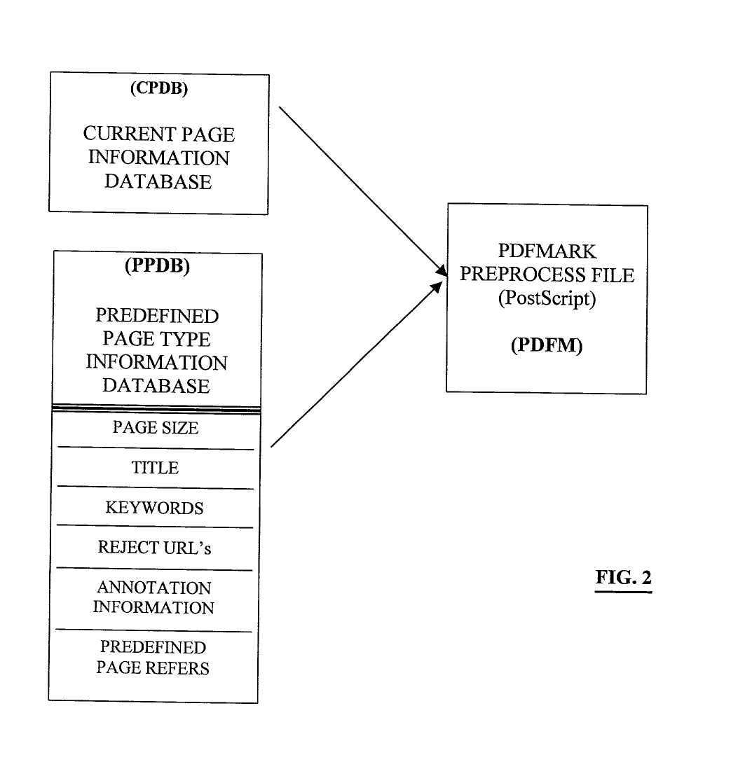

All of the extracted information is stored in the current page information database (CPDB). With reference now to FIG. 2, for each PostScript input file (PSI), the current page information database (CPDB) is used together with a predefined page type information database (PPDB) that is defined in advance according to the type of newspaper page represented by the particular PostScript input file (PSI) currently being processed. A predefined page type information database (PPDB) exists for each type of newspaper page—editorial, full-page advertisement, classified, etc. In particular, the current page information database (CPDB) is used together with the relevant predefined page type information database (PPDB) to derive a PDFMark PostScript file (PDFM) that describes the general layout or template of the newspaper page being processed.

As noted, the contents of the predefined page type information database (PPDB) vary depending upon the type of newspaper page being processed. In one example, as shown in FIG. 2, the predefined page type information database (PPDB) includes information that describes the size of the page, the title of the page and keywords that, if present on the page, are to be made active and selectable for linking to a URL or other resource. The predefined page type information database (PPDB) also includes a listing of reject URL's and/or reject e-mail addresses that are not to be made active and selectable as deemed appropriate due to inappropriate content or any other reason. The predefined page type information database (PPDB) also includes annotation information that includes, for example, information concerning general page layout, types and colors of borders around articles, images and/or advertisements. Also, information about predefined page refers is held in the predefined page type information database (PPDB). Predefined refers are those refers that are always present on a particular page type (e.g., on a section front page to direct the reader's attention to a story within the section) and are identified as being present even if they are not identified during the above-described parsing of the PostScript input file (PSI) due to unconventional font or text attributes.

The PDFMark file (PDFM) generated based upon the current and predefined databases (CPDB, PPDB) is a prolog PostScript program adapted for submission to an Acrobat Distiller or like interpreter prior to a PostScript file to facilitate the creation of a PDF file. In this case, the PDFMark preprocess file (PDFM) describes the newspaper page for which a PDF file is being created so that, in the resultant PDF file that is created, refers are active and selectable (hypertext) by end-users for navigation to other PDF data files, URL's and e-mail address are active and selectable by end-users as desired so that an associated auxiliary process such as a web browser or e-mail program is launched, bookmarks and font information/tables are defined and keywords are defined and are active and selectable by end-users to link to a URL, e-mail address, or other resource or process. The PDFMark file (PDFM) also describes image size and information so that supplemental images can be selected and associated with that location on the page of the resultant PDF file. In this manner, an end-user can click on an image location in the PDF file created based upon the PDFMark file (PDFM) so that supplemental images (or video and/or audio data) are then displayed to the end-user. The PDFMark file also describes cropping information for the page being processed so that extraneous information on the newspaper page not visible in the hard-copy newspaper is also not visible in the PDF file resulting from the present invention.

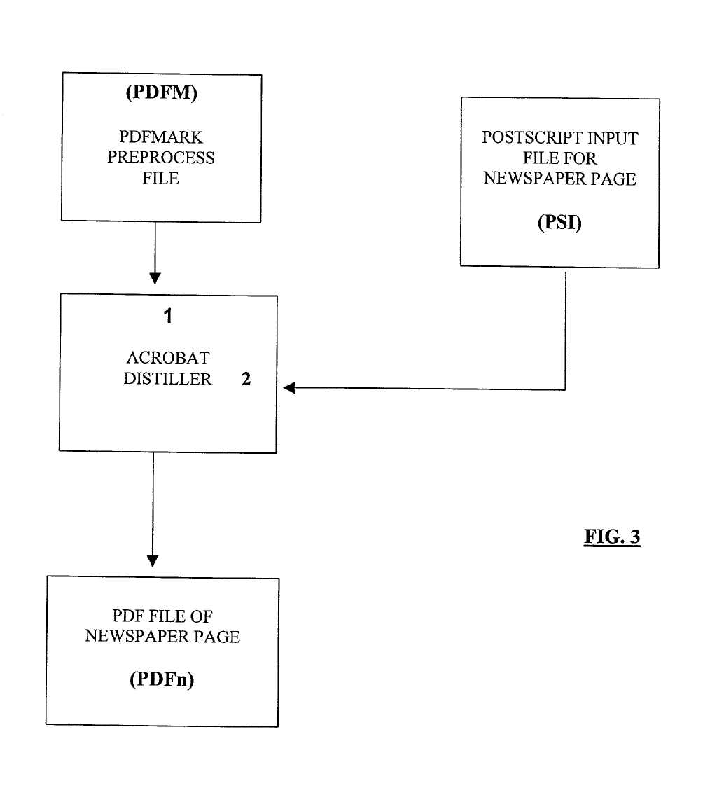

As shown in FIG. 3, the PDFMark preprocess file (PDFM) is input to the Acrobat Distiller interpreter prior to input of the PostScript input file (PSI) for the newspaper page being processed. The Acrobat Distiller interpreter outputs a PDF file (PDFn) that represents only the newspaper page currently being processed. The PDF file (PDFn) is defined according to the relevant PDFMark preprocess file as described above using the data from the PostScript input file (PSI) so that the refers, URL's, e-mail addresses, keywords, images and/or other portions of the resultant PDF file (PDFn) as noted are selectable by an end-user when the PDF file (PDFn) is displayed to the end user on a computer display terminal.

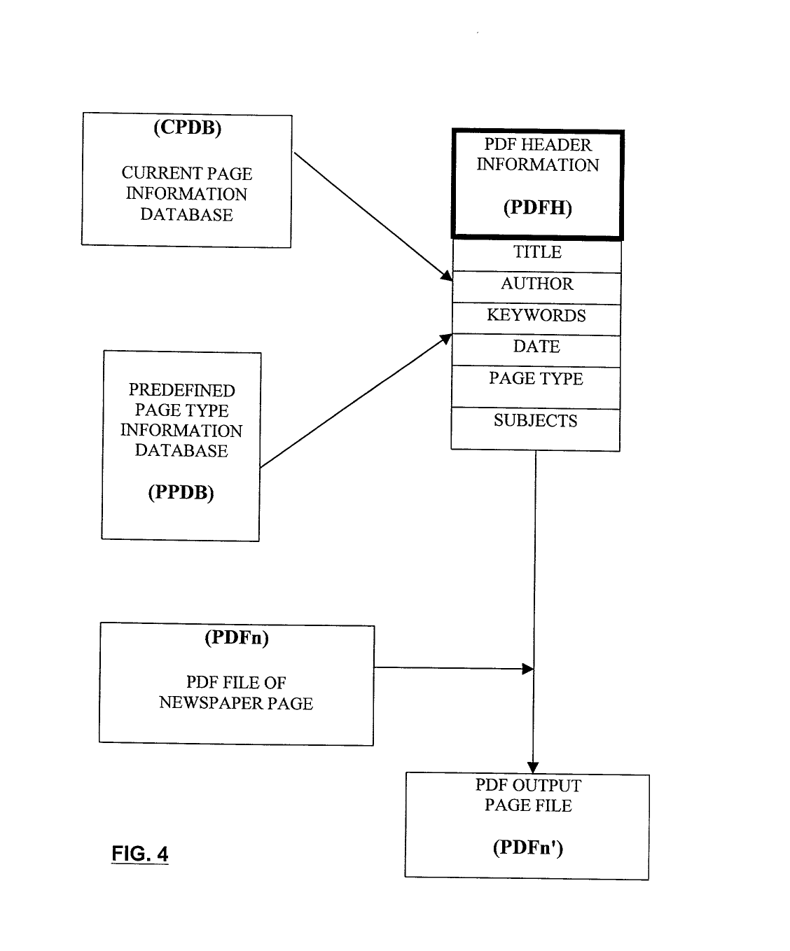

FIG. 4 discloses a method for generating PDF header information (PDFH) and appending the header information to the PDF file (PDFn) that represents the newspaper page presently being processed. In particular, the current page information database (CPDB) and the predefined page type information database (PPDB) are again accessed and used to develop the PDF header information (PDFH) for the page (PDFn). For the PDF file (PDFn), it is most preferred that the PDF header information include a title of the entire page (e.g., “A1” or “C2”), an author of the overall page (e.g., the editor's name), keywords that are present in the page, a date, a page type (e.g., obituary, classified, etc.) and a list of subject covered on the page. As shown in FIG. 4, the PDF file (PDFn) and the PDF header information (PDFH) are merged or combined to define an output PDF file (PDFn′) for the newspaper page being processed.

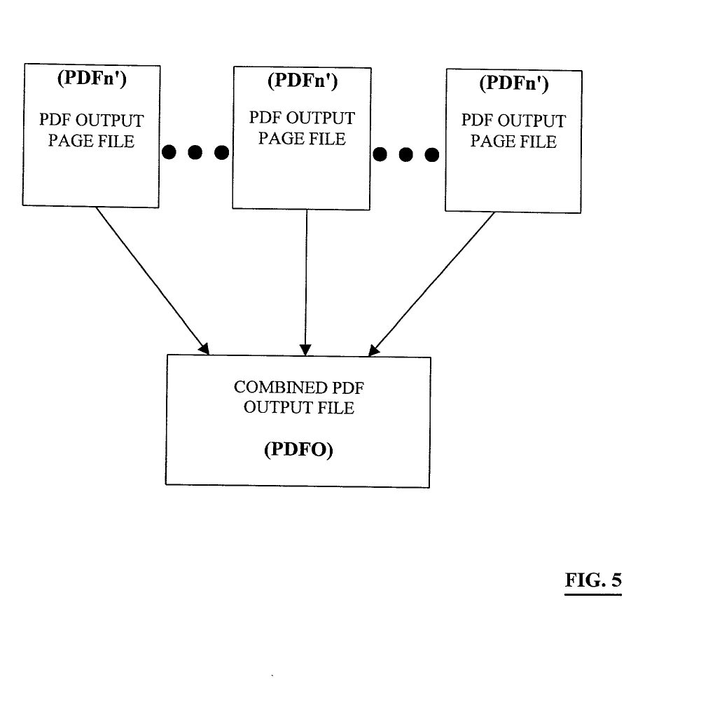

As shown in FIG. 5, based the PDF header information (PDFH), related PDF output page files (PDFn′) are combined into a single combined PDF output file (PDFO). More particularly, the PDF header information in each of the PDF output page files (PDFn′) is accessed and used to associate related files. In one example, PDF output page files are associated based upon newspaper date, section, and page number header information so that the combined PDF output file (PDFO) has a structure that mimics the hard-copy newspaper being converted to PDF format. The combined PDF output file (PDFO) can be stored on CD-ROM, made available on-line over a computer network or made available to end-users by any suitable and convenient means. Those of ordinary skill in the art will also recognize that the combined PDF output file (PDFO) can be an entire newspaper, multiple newspapers, a single newspaper section or simply an individual newspaper page. The invention is not to be limited to any particular type of combined PDF output file (PDFO).

Those of ordinary skill in the art will also recognize that the foregoing method allows for implementation of novel and unobvious business methods. In one example, the “reject URL” information contained in the predefined page type information database (PPDB) is used to ensure that URL's listed in the text of the paper are activated as a hypertext link only if the business entity or individual associated with the link has paid a fee to the newspaper or is an advertiser.

In another embodiment, advertisements including a URL or electronic mail address are subjected to an additional charge if the advertiser desires the URL/e-mail link to be activated and available for selection by the end-user. In still another embodiment, a website or electronic mail address of each advertiser in the paper is accessible to the end user simply by selecting the advertisement without regard to the presence of a URL/e-mail address in the advertisement, i.e., the end-user simply “clicks on” the advertisement itself to be link to the advertiser's website or electronic mail address.

In a further embodiment, a specialized combined PDF output file (PDFO) is created and sold to end-users. A specialized combined PDF output file can be a group of newspapers, stories or other information that is combined as desired by an end-user for his/her convenience. For example, a user may desire to have a combined PDF output file (PDFO) that includes all previously published newspapers that include one or more keywords. In another example, an end-user may desire a combined PDF output file that includes all previously published newspapers from his/her birthday since he/she was born.

Modifications and alterations will occur to others of ordinary skill in the art upon reading the foregoing disclosure. It is intended that the invention be construed as including all such modifications and alterations. Although the invention has been described with reference to generation of a PDF file from a PostScript file, those of ordinary skill in the art will recognize that other languages and file formats can be used without departing from the overall scope and intent of the present invention. For example, it is contemplated that XML files be substituted for the PDF files according to the present invention.

Having thus described the preferred embodiments, what is claimed is:

1. A method for generating an interactive enhanced electronic newspaper file, said method comprising:
a) receiving input data in a select input data format that represents a current page of a corresponding hardcopy newspaper, said current page having a predefined page type selected from one of a plurality of different page types;
b) parsing said input data to extract therefrom page information data that represent a general layout of said current page of the corresponding hardcopy newspaper;
c) storing said page information data extracted from said input data in a current page information database;
d) selecting one of a plurality of different predefined page information databases that correspond respectively to said plurality of different page types based upon said predefined page type;
e) deriving a preprocess file for said current page using data from said current page information database and data from said select one of said plurality of different predefined page type information databases, said preprocess file defining said general layout that corresponds to said current page of said corresponding hardcopy newspaper and defining at least select portions of said layout to be links that are active and selectable by an end user when said current page output data file is displayed to an end user on a computer display terminal;
f) inputting said preprocess file and said input data that represents said current page of said corresponding hardcopy newspaper into an interpreter that generates a current page output data file that defines said current page of said corresponding hardcopy newspaper according to said layout and in terms of a select output data format different from said input data format, said current page output data file including output data that are associated with said links so as to be active and selectable by an end user when said current page output data file is displayed to an end user on a computer display terminal to link said current page output data file to one of: (i) another output data file; (ii) a supplemental data file; and, (iii) an auxiliary process;
g) storing said current page output data file; and,
h) repeating steps a) through g) for all pages of said hardcopy newspaper to generate and store a plurality of current page output data files.

2. The method as set forth in claim 1, further comprising, after step h):
combining said plurality of different current page output data files into a single combined data output file.

3. The method as set forth in claim 2, further comprising:
storing said single combined data output file on one of a CD-ROM and a computer server for access by end-users.

4. The method as set forth in claim 1, wherein said step of parsing said input data to extract page information data comprises extracting at least two of: (i) text data; (ii) text position data; (iii) font information data; (iv) image position and size data; and, (v) bitmap data that define a bitmap of said current page of said corresponding hardcopy newspaper.

5. The method as set forth in claim 1, wherein said step of parsing said input data to extract page information data comprises extracting: (i) text data; (ii) text position data; (iii) font information data; and, (iv) image position and size data.

6. The method as set forth in claim 5, wherein said step of parsing said input data to extract page information data further comprises extracting: (v) bitmap data that define a bitmap of said current page of said corresponding hardcopy newspaper.

7. The method as set forth in claim 5, wherein said step e) of deriving a preprocess file comprises:
processing said extracted page information data to locate a presence and a location of select page definition information on said current page of said corresponding hardcopy newspaper.

8. The method as set forth in claim 7, wherein said select page definition data identified and located by said step of processing said extracted page information data comprises at least a plurality of: (i) refer text that refers a reader to a page other than said current page of said corresponding hardcopy newspaper; (ii) headline text that introduces a story; (iii) URL text that defines a URL for a web site; (iv) e-mail address text that defines an e-mail address; (v) word location data that define a location for each word of text on said current page of said corresponding hardcopy newspaper; (vi) character location data that define a location for each constituent character of each of said words of text on said current page of said corresponding hardcopy newspaper; (vii) headline font data that facilitate identification of headlines on said current page of said corresponding hardcopy newspaper; and, (viii) refer font data that indicate a presence of text that refers a reader to a page other than said current page of said corresponding hardcopy newspaper.

9. The method as set forth in claim 7, wherein said select page definition data identified and located by said step of processing said extracted page information data comprises: (i) refer text that refers a reader to a page other than said current page of said corresponding hardcopy newspaper; (ii) headline text that introduces a story; (iii) URL text that defines a URL for a web site; (iv) e-mail address text that defines an e-mail address; (v) word location data that define a location for each word of text on said current page of said corresponding hardcopy newspaper; (vi) character location data that define a location for each constituent character of each of said words of text on said current page of said corresponding hardcopy newspaper; (vii) headline font data that facilitate identification of headlines on said current page of said corresponding hardcopy newspaper; and, (viii) refer font data that indicate a presence of text that refers a reader to a page other than said current page of said corresponding hardcopy newspaper.

10. The method as set forth in claim 8, wherein said links defined by said preprocess file comprise links associated with at least said refer text, said URL text and said e-mail address text.

11. The method as set forth in claim 8, further comprising:
using said headline font data to derive story location data that define locations of stories on said current page of said corresponding hardcopy newspaper.

12. The method as set forth in claim 11, wherein said step of deriving story location data comprises:
identifying a font that indicates a story headline;
identifying a font used for story text; and,
identifying a change of font between said story text and a subsequent headline.

13. The method as set forth in claim 8, wherein said select input data format is Adobe PostScript, said select output data format is Adobe portable document format (PDF) and said preprocess file is a PDFmark file.

14. The method as set forth in claim 13, wherein said step f) inputting said preprocess file and said input data into an interpreter comprises inputting said preprocess file and said input data into an Adobe Acrobat Distiller interpreter program.

15. The method as set forth in claim 10, wherein:
said refer text links said current page output data file to another output data file to be displayed to an end user;
said URL text links said current page output data file to a web browser; and,
said e-mail address text links said current page output data file to an e-mail program.

16. The method as set forth in claim 10, further comprising: storing supplemental image data that relate to image data that define an image of said current page output data, wherein said links defined by said preprocess file further comprise a link that is associated with said image of said current page output data, whereby said supplemental image data are displayed to an end user when said end user selects said image of said current page output data file.

17. The method as set forth in claim 7, wherein said select page definition data identified and located by said step of processing said extracted page information data comprises at least one advertisement, and wherein said links defined by said preprocess file comprise a link to said advertisement, said method further comprising associating a URL with said at least one advertisement whereby an end user navigates to said URL that is associated with said advertisement when the advertisement is selected.

18. A method comprising:
defining a newspaper page in an input data file having a first data format;
extracting from said input data file at least a plurality of: text data; text position data; font information data; image position and size data; page refer data; URL data; e-mail data; story location data; and, advertisement location data;
storing said extracted data in a current page information database;
selecting one of a plurality of predefined page type information databases that respectively include data that relate to particular page types;
using data from both said current page information database and said selected predefined page type information database to define a template file of said newspaper page; and,
generating an output data file having a second data format that is different from said first data format by converting a copy of said input data file to said second data format based upon said template file, said template file defining at least one link in said output data file that links data of said output data file to at least one of: a related output data file; a supplemental data file; and, an auxiliary process.

19. The method as set forth in claim 18, wherein said supplemental data file comprises at least one of a digital image data file and an audio data file that relates to information represented by said output data file.

20. The method as set forth in claim 19, wherein said auxiliary process comprises one of a web-browser and an electronic mail program.
